(19) United States
(12) Patent Application Publication
(10) Pub. No.: US 2007/0194061 A1
(43) Pub. Date: Aug. 23, 2007

(54) Laser trimmed drip free bottle

(75) Inventors: Phillip M. Rosegrant, Wyoming, OH (US); John P. Hansen, Wadsworth, OH (US)

Correspondence Address: CALFEE HALTER & GRISWOLD, LLP, 800 SUPERIOR AVENUE, SUITE 1400, CLEVELAND, OH, 44114, US

(73) Assignee: Smucker Fruit Processing Company, Salinas, CA (US)

(21) Appl. No.: 11/593,214

(22) Filed: Nov. 6, 2006

Related U.S. Application Data
(60) Provisional application No. 60/733,626, filed on Nov. 4, 2005.

(51) Int. Cl. B65D 5/72; B29C 71/02; B29C 71/04

(52) U.S. Cl. 222/571; 264/320; 264/80; 264/482; 264/489; 264/492

(57) ABSTRACT

Methods for forming drip-free pouring surfaces for polymeric containers. The drip-free pouring surfaces are formed by heating a pouring surface, without physical contact, such as with a laser or other heat source. In one embodiment, the drip-free pouring surfaces are substantially mushroom-shaped in cross section. Also provided are containers having drip-free pour surfaces formed by the methods described herein.

### CROSS-REFERENCE TO RELATED APPLICATIONS

This application claims priority to, and any other benefit of, U.S. Provisional Patent Application No. 60/733,626 filed Nov. 4, 2005, the entirety of which is incorporated herein, by reference.

### BACKGROUND

Liquid consumer goods, such as cooking oils, tend to have droplets of the liquid drip over the lip of the pour spout when poured from the container. The drips are not only messy, but also make the outside of the bottle sticky, which could lead to contamination. One method that has been used to make drip free bottles is to create a drip free lip on the bottle during the injection molding process. This method is relatively expensive because of the amount of extra plastic that must be used when the entire finish of the bottle is injection molded. Another method for making drip free bottles involves separately forming a bottle and a drip free injection molded fitment and then joining the separately made bottle and fitment to form a drip free bottle. This method, however, is costly because the drip free fitment and the bottle are two separate articles that must be joined together. Finally, drip free lips have also been formed on bottles mechanically, using frictional heating and physically contacting the bottle surface. This method also has drawbacks, both in maintenance costs as well as the risk of contamination when the bottle lip comes into physical contact with the machinery.

Accordingly, a new method is needed to form drip free bottles. The new method should be able to be used with preformed bottles, eliminating the need for extra plastic in the injection molding process, eliminating the need to join two separate pieces to form the bottle, and eliminating the need to physically contact the bottle, which in turn decreases machinery maintenance costs and risk of contamination.

### SUMMARY OF THE INVENTION

Provided herein are methods for forming drip-free pouring surfaces and the pouring surfaces formed by those methods. In one method, the edge of a pouring surface is heated, without physically contacting the surface, to form a drip-free profile. This method may be used when the pouring surface already has an edge, or when the edge of the pouring surface is formed during the heating process. The heat source may be virtually any source that provides sufficient energy to melt the edge of the pouring surface and form the drip-free profile. Some sources of heat include lasers, convection sources, infrared sources, microwave sources, superheated steam, electromagnetic radiation sources, sources of flame, and combinations thereof. In one embodiment, the heat source is a laser. The pouring surface may be any polymeric material that forms the drip-free profile when heated according to the methods provided herein. Some polymers that may be used include, but are not limited to polyolefins, PET, HDPE, PVC, polystyrene, nylon, polypropylene and so forth.

Also provided are containers having the drip-free pouring surfaces described herein. In one embodiment, the container includes a reservoir for storing a fluid, and at least one pouring surface forming an opening through which fluid may be poured from the reservoir, and wherein the pouring surface has a drip-free profile formed by the methods described herein.

### BRIEF DESCRIPTION OF THE DRAWINGS

FIG. 1 depicts a cross-sectional comparison of (a) a drip free pour spout as formed using an injection molding or frictional heating/contact process and (b) an exemplary drip free pour spout formed using the methods described herein.

FIG. 2 shows the actual profile of the exemplary drip free bottle lip made using the methods described herein.

FIG. 3 shows five exemplary flange profiles that could be used with the methods described herein.

FIG. 4 shows an exemplary bottle finish with a horizontal flange.

FIG. 5 shows an exemplary embodiment wherein the drip free lip is created on a vertical wall of the bottle.

### DETAILED DESCRIPTION OF THE INVENTION

Provided herein are drip free bottles having pouring surfaces that are resistant to dripping, as well as methods of making bottles and pour spouts with drip-free profiles. The methods and the bottles made by those methods exhibit good drip free properties while being less expensive to produce than drip free bottles made by other methods. The methods for making a drip free pour surfaces may be used with any plastic bottles that are commonly used for household or industrial liquids or solutions that are typically poured from the bottle. The drip-free profiles formed using the methods described herein are particularly useful for such things as oils, such as cooking oils, which tend to drip when poured from a bottle. Representative plastics include, but are not limited to polyolefins, PET, HDPE, PVC, polystyrene, nylon, polypropylene and so forth.

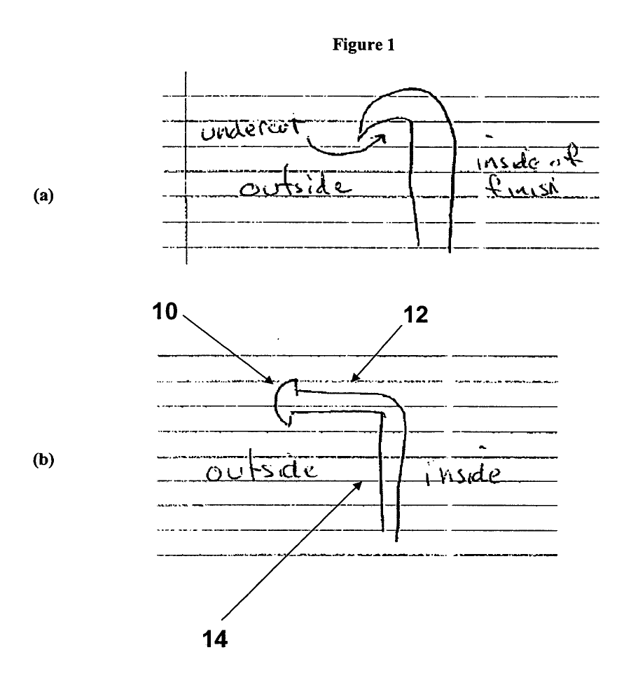

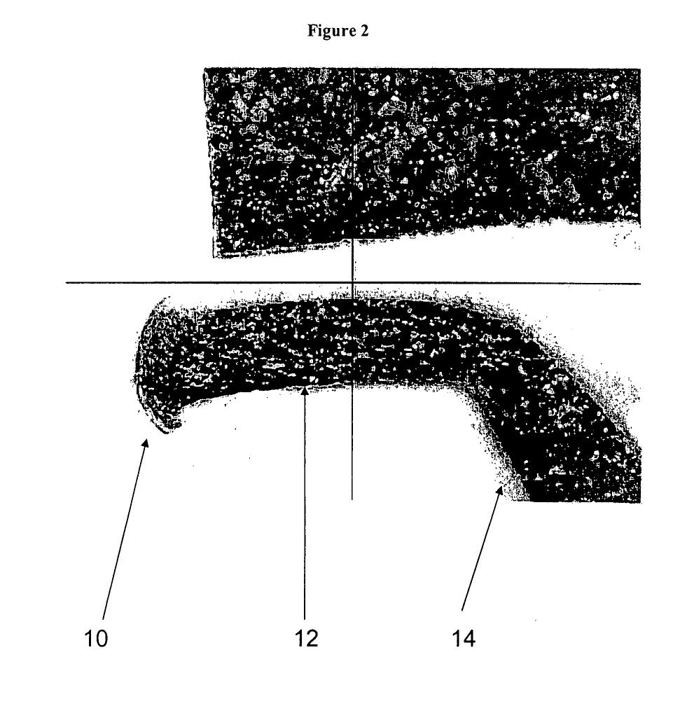

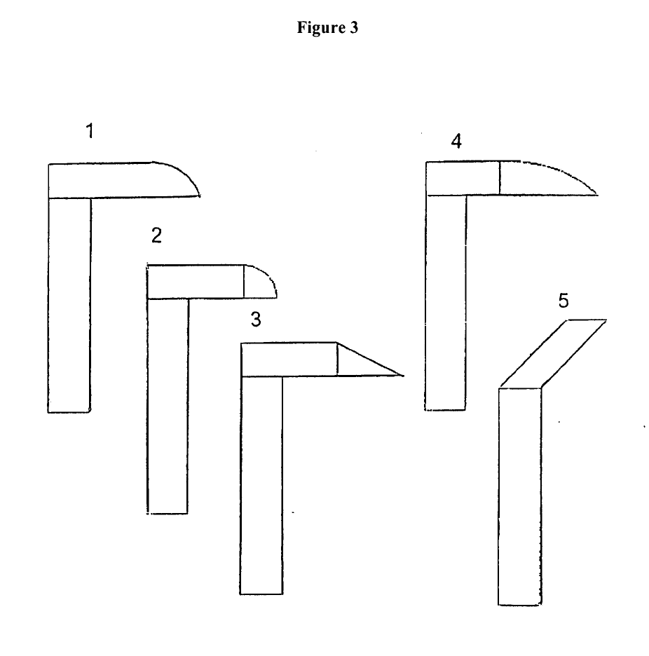

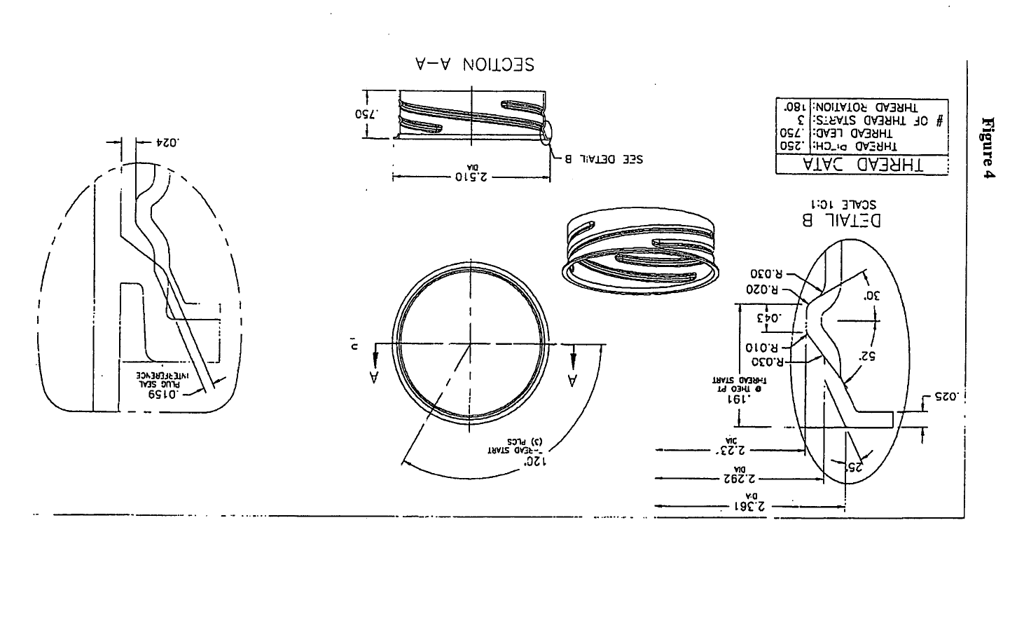

The geometry of the pour spout edge 10 created by the laser cut is mushroom shaped in cross section, which is shown at the end of an approximately horizontal flange 12 from neck 14 in FIGS. 1 and 2. This geometry uses the surface tension of the oil or other viscous liquid to pull the oil back inside the bottle instead of dripping or running down the outside of the bottle. The geometry of the laser trimmed bottle is compared to that of the drip free lip that is formed on during the injection molding process in FIG. 1. Using the methods described herein, the laser melts the plastic creating a mushroom shape at the end of the flange as shown in FIGS. 1 and 2. FIG. 3 shows several flange profiles that may be used with the methods described herein. FIG. 4 shows a representative bottle top with a horizontal flange. Perhaps only a portion of the mushroom-shaped pour spout edge 10 is needed to provide reduced dripping, e.g., a lower or outside portion of the edge 10 contacting the oil or other fluid.

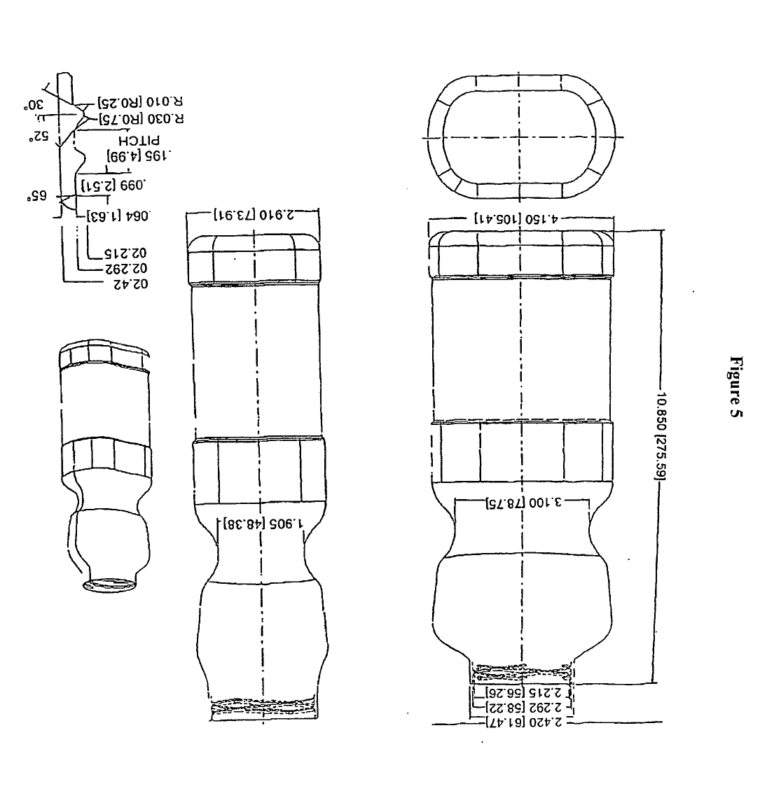

In another exemplary embodiment, the drip free lip may be formed on a vertical wall of the bottle, thus eliminating the need for a horizontal flange. FIG. 5 shows a bottle with no horizontal flange that may be used in accordance with the methods described herein. In another embodiment, the drip free lip could be formed on a flange at any angle between 90 degrees and 0 degrees off the center line of the bottle. In another embodiment, the drip free lip may be formed on a pour spout that has U-shaped, C-shaped or V-shaped pour spout, such as those used with a gravity flow back channel.

The laser trimming method for making a drip free bottle has several advantages over other known methods for making drip free bottles. First, there is no physical contact with the bottle therefore reduced risk of product contamination. There are no machine parts that wear during operation due to physically reforming the bottle lip. Trimming a horizontal flange eliminates the need to rotate the bottle during laser trimming; the laser beam or other heat source is electrically steered. Also, the amount of plastic required is less for a blow molded finish than for an injection molded bottle finish making the bottle less expensive.

The laser used can be any laser that has sufficient power and power density to melt a bottle thickness of the polymer used to form the bottle. In one embodiment, a CO₂ laser is used, however, in other embodiments, different lasers may be used provided the power density of the laser is sufficient to cut the plastic of the pouring surface. The polymer may be selected from PET, HDPE, polyethylene, polystyrene, polypropylene, PVC, and so forth. For an exemplary PET bottle that is thirty-five thousands thick, the laser and power would be chosen such that the laser is capable of trimming the PET. One skilled in the art would be able to select a laser of appropriate wavelength and power to trim a selected plastic of known thickness.

Laser trimming is well-known in the art and the various embodiments of the present invention may be implemented using known techniques. Briefly, the following exemplary method may be used to form the exemplary drip free lip on a horizontal flange according to the present invention: a laser having sufficient power to melt the plastic of interest, is directed to a steering mirror mounted above the center line of the bottle to be trimmed; the laser beam is focused such that the maximum power density is at the flange; and the mirror, which may be driven by servo motors, is used to steer the laser beam around the bottle, trimming the flange all of the way around the bottle to form the drip free lip described herein. No physical contact with the drip free lip is necessary; the mushroom-shaped profile of FIGS. 1-2 is a natural result of using an appropriate laser to trim the horizontal flange 12.

In another embodiment, the drip-free lip could be formed using any type of non-contact heat, such as a laser, a burner or other source of flame, a convection source, an infrared source, a microwave source, superheated steam, radiant energy, electromagnetic radiation or combinations thereof.

In an exemplary vertical cut embodiment, the laser may be directed to a mirror mounted above the center line of the bottle. The laser may be focused to have maximum power density at the surface of the bottle that is to be trimmed. The mirror may be used to steer the beam around the bottle, trimming the plastic and forming the drip free lip described herein.

The exemplary drip free bottles described herein are particularly useful for cooking oils, but may also be useful for other edible liquids including syrups, sauces, drinks, and so forth, as well as non-edible liquids, including but not limited to cleaning products such as laundry detergents and fabric softeners, household or automotive cleaners; personal care items, such as shampoos, conditioners, moisturizers, cleansers; and other applications, such as pesticides, herbicides, plant foods and fertilizers.

The specific embodiments described herein are for illustrative purpose and are not meant to limit the scope of this invention as described in the claims.

The invention claimed is:

1. A method for forming a drip-free pouring surface, comprising the steps of:
providing a pouring surface, the pouring surface having an edge; and
heating the edge of the pouring surface with a heat source, without physically contacting the pouring surface and the heat source, to form a drip-free profile.

2. The method of claim 1 wherein the heat source is selected from the group consisting of a laser, a flame, a convection source, an infrared source, a microwave source, superheated steam, electromagnetic radiation and combinations thereof.

3. The method of claim 2 wherein the heat source is a laser.

4. The method of claim 1 wherein the pouring surface is selected from the group consisting of spouts, rims, and flanges.

5. The method of claim 1 wherein the pouring surface comprises a polymer.

6. The method of claim 5 wherein the polymer is selected from the group consisting of PET, HDPE, polypropylene, and combinations thereof.

7. The method of claim 1 wherein the drip-free profile has a mushroom-shaped cross-section.

8. The method of claim 1 wherein the pouring surface is part of a container.

9. The method of claim 8 wherein the container is a bottle.

10. The method of claim 8 wherein the drip-free profile is formed while the pouring spout is on the container.

11. The method of claim 8 wherein the pouring spout is coupled with the container after the drip-free profile is formed.

12. A method of making a drip-free container, the method comprising the steps of:
providing a container having a polymeric pouring surface; and
heating an edge of the pouring surface with a laser to form a drip-free profile.

13. A container, comprising:
a reservoir for storing a fluid; and
at least one pouring surface forming an opening through which fluid may be poured from the reservoir, and wherein the at least one pouring surface comprises a drip-free profile that is substantially mushroom-shaped in cross section.

14. The container of claim 13 wherein the substantially mushroom-shaped drip-free profile is formed by cutting the at least one pouring surface with a laser.

15. The container of claim 13 wherein the substantially mushroom-shaped drip-free profile is formed by heating the at least one pouring surface until a portion retracts to form the substantially mushroom-shaped drip-free profile.

16. The container of claim 13 wherein,
the reservoir comprises a bottom surface for supporting the bottle on a support surface; and
the at least one pouring surface comprises a flange proximate the opening, the flange being between about 90 degrees to about 0 degree relative to the support surface, and the drip-free profile that is substantially mushroom-shaped in cross section is formed at a distal end of the flange.

17. The container of claim 16 wherein the flange is substantially parallel to the support surface.

18. The bottle of claim 16 wherein the substantially mushroom-shaped drip-free profile is formed by cutting the at least one pouring surface with a laser.

19. The bottle of claim 16 wherein the substantially mushroom-shaped drip-free profile is formed by heating the at least one pouring surface until a portion retracts to form the substantially mushroom-shaped drip-free profile.

20. The bottle of claim 16 wherein the at least one pouring surface comprises an annular flange around the opening and the drip-free profile that is substantially mushroom-shaped in cross section is formed around a distal edge of the annular flange.
